(19) United States
(12) Patent Application Publication
(10) Pub. No.: US 2010/0051820 A1
(43) Pub. Date: Mar. 4, 2010

(54) X-RAY DETECTING ELEMENT

(75) Inventor: Yoshihiro OKADA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/548,465

(22) Filed: Aug. 27, 2009

(30) Foreign Application Priority Data
Aug. 29, 2008 (JP) 2008-221550

(51) Int. Cl. G01T 1/24

(52) U.S. Cl. 250/370.09

(57) ABSTRACT

The present invention provides an X-ray detecting element that obtains radiation images by X-rays of different energies by irradiation of X-rays at a single time, without positional offset arising. Two X-ray detecting sections are provided so as to be layered at a substrate in a direction of irradiation of X-rays. A first X-ray detecting section detects irradiated X-rays, and a second X-ray detecting section detects X-rays that are transmitted through the first X-ray detecting section.

### CROSS-REFERENCE TO RELATED APPLICATION

This application claims priority under 35 USC 119 from Japanese Patent Application No. 2008-221550, filed on Aug. 29, 2008, the disclosure of which is incorporated by reference herein.

### BACKGROUND OF THE INVENTION

1. Field of the Invention

The present invention relates to an X-ray detecting element. In particular, the present invention relates to an X-ray detecting element that detects an image expressed by irradiated X-rays.

2. Description of the Related Art

X-ray detecting elements such as FPDs (flat panel detectors), in which an X-ray sensitive layer is disposed on a TFT (thin film transistor) active matrix substrate and that can convert X-ray information directly into digital data, and the like have been put into practice in recent years. As compared with a conventional imaging plate, an image can be confirmed immediately at an X-ray detecting element. Further, the FPD has the advantage that video images as well can be confirmed. Therefore, the popularization of FPDs has advanced rapidly.

Various types of X-ray detecting elements have been proposed. For example, there is a direct-conversion-type X-ray detecting element that converts X-rays directly into charges at a semiconductor layer, and accumulates the charges. Moreover, there is an indirect-conversion-type X-ray detecting element that once converts X-rays into light at a scintillator (a wavelength converting portion) of CsI:Tl, GOS (Gd2O2S:Tb), or the like, and, at sensor portions such as photodiodes or the like, converts the converted light into charges, and accumulates the charges.

The following technique is known in the photographing of radiation images. By photographing the same region of a subject at different tube voltages, and carrying out image processing (hereinafter called “subtraction image processing”) that weights the radiation images obtained by the photographing at the respective tube voltages and computes the difference therebetween, a radiation image (hereinafter called “energy subtraction image”) is obtained in which one of an image portion, that corresponds to hard tissue such as bones or the like within the image, and an image portion, that corresponds to soft tissue, is emphasized and the other is removed. For example, when using an energy subtraction image that corresponds to soft tissue of the chest region, pathological changes that are hidden by the ribs can be seen. Accordingly, this technique can improve diagnostic performance.

In the case when obtaining an energy subtraction image with an analog X-ray film or an imaging plate, X-rays are irradiated a single time while two X-ray films or imaging plates are superposed one on the other, and the energy subtraction image can be obtained by carrying out subtraction image processing on the two radiation images that are obtained from the respective X-ray films or imaging plates.

On the other hand, with an X-ray detecting element, there is proposed a method of photographing that, when an energy subtraction image is to be obtained, X-rays of different energies are irradiated two times in succession with respect to a single X-ray detecting element, and two radiation images are obtained. Further, with an X-ray detecting element, there is proposed a method in which two radiation images are obtained by irradiating X-rays one time with two X-ray detecting elements superposed one on the other, similarly to the case of X-ray films or imaging plates.

In the former photographing method, the irradiation of X-rays is carried out twice. The amount of radiation to which the subject is exposed thereby increases. Further, in the former photographing method, the images become offset between the two times irradiation is carried out.

In the latter photographing method, image quality deteriorates due to offset between the two X-ray detecting elements that is caused by dimensional errors from the time of manufacturing the X-ray detecting elements, or by vibration or expansion. Further, in this latter photographing method, because the X-rays are irradiated radially from the X-ray source, if two of the X-ray detecting elements are superposed one on the other, the image sizes of the radiation images that are obtained from the respective X-ray detecting elements differ. Still further, costs in the latter photographing method are higher than in a case of using a single X-ray detecting element.

Japanese Patent Application Laid-Open (JP-A) No. 2000-298198 discloses a technique of obtaining an energy subtraction image by layering plural individual radiation detecting layers and carrying out subtraction image processing on the radiation images obtained from the respective individual radiation detecting layers. In this case, correction of the pixel size is carried out so that the pixel sizes of the respective radiation images become the same.

However, in a case of obtaining radiation images by X-rays of different energies by the irradiation of X-rays a single time, it is preferable that there be no positional offset among the respective radiation images.

### SUMMARY OF THE INVENTION

The present invention provides an X-ray detecting element that can obtain radiation images by X-rays of different energies by the irradiation of X-rays a single time, without positional offset arising.

An X-ray detecting element of a first aspect includes: a first X-ray detecting section provided on one surface of a substrate, and detecting irradiated X-rays, and generating charges; a second X-ray detecting section provided so as to be layered, in a direction of irradiation of X-rays, with respect to the first X-ray detecting section, and detecting X-rays that are transmitted through the first X-ray detecting section, and generating charges; a first switching element provided on the one surface of the substrate and connected to the first X-ray detecting section, for reading-out charges that are generated at the first X-ray detecting section; and a second switching element provided on the one surface of the substrate and connected to the second X-ray detecting section, for reading-out charges that are generated at the second X-ray detecting section.

In the X-ray detecting element of the first aspect, the first X-ray detecting section, that detects irradiated X-rays and generates charges, is provided on one surface of the substrate. Further, in the X-ray detecting element of the first aspect, the second X-ray detecting section, that detects X-rays and generates charges, is provided so as to be layered, in a direction of irradiation of the X-rays, with respect to the first X-ray detecting section. The second X-ray detecting section detects X-rays that are transmitted through the first X-ray detecting section, and generates charges.

Moreover, in the present invention, the first switching element and the second switching element are provided on the one surface of the substrate. The first switching element is connected to the first X-ray detecting section, and is for reading-out the charges generated at the first X-ray detecting section. The second switching element is connected to the second X-ray detecting section, and is for reading-out the charges generated at the second X-ray detecting section.

In this way, in the first aspect, the first X-ray detecting section and the second X-ray detecting section are provided at the substrate so as to be layered in the direction in which the X-rays are irradiated. Irradiated X-rays are detected at the first X-ray detecting section, and the X-rays, that are transmitted through the first X-ray detecting section, are detected at the second X-ray detecting section. Accordingly, the X-ray detecting element of the first aspect obtains radiation images by X-rays of different energies by the irradiation of X-rays a single time, without positional offset arising.

In a second aspect, in the above-described aspect, the substrate may be light-transmissive, and the second X-ray detecting section may be configured to include: a second wavelength converting portion provided on another surface of the substrate, and generating light when X-rays are irradiated thereon; and a second sensor portion provided on the one surface of the substrate, and generating charges due to illuminated light, that is generated at the second wavelength converting portion.

In a third aspect, in the above-described aspect, the first switching element and the second switching element may be formed in the same layer.

In a fourth aspect, in the above-described aspect, the second sensor portion may be formed in a same layer as the first switching element and the second switching element, and the first X-ray detecting section may be provided, via an interlayer insulating film, at a layer disposed above the layer which includes the first switching element and the second switching element.

In a fifth aspect, in the above-described aspect, the first switching element and the second switching element may be thin-film transistors, the second sensor portion may be an MIS photodiode, and semiconductor active layers of the thin-film transistors that are the first switching element and the second switching element and a semiconductor layer of the MIS photodiode that is the second sensor portion are formed in same layer, and insulating layers of the thin-film transistors and an insulating layer of the photodiode, may be formed in a same layer.

In a sixth aspect, in the above-described aspect, the second X-ray detecting section may have, at a first X-ray detecting section side thereof, a filter that absorbs low energy x-rays.

In a seventh aspect, in the above-described aspect, the first X-ray detecting section may also function as the filter.

In an eighth aspect, in the above-described aspect, the first X-ray detecting section may be provided so as to cover a region where the second X-ray detecting section is provided.

In a ninth aspect, in the above-described aspect, the first X-ray detecting section may be configured to include a semiconductor layer that generates charges when X-rays are irradiated thereto.

In a tenth aspect, in the above-described aspect, the first X-ray detecting section may be configured to include: a first wavelength converting portion generating light when X-rays are irradiated thereto.; and a first sensor portion generating charges due to illuminated light, that is generated at the first wavelength converting portion, and the first wavelength converting portion may be provided so as to cover the first sensor portion.

In an eleventh aspect, in the above-described aspect, the first X-ray detecting section may be formed so as to not have a K absorption edge at a high energy portion.

In a twelfth aspect, in the above-described aspect, plural pixel portions, that detect X-rays as information of pixels forming a radiation image, may be provided at the substrate in a surface direction, and plural first X-ray detecting sections, second X-ray detecting sections, first switching elements, and second switching elements may be provided for the respective pixel portions.

The X-ray detecting element of the present invention obtains radiation images by X-rays of different energies by the irradiation of X-rays a single time, without positional offset arising.

### BRIEF DESCRIPTION OF THE DRAWINGS

Exemplary embodiments of the present invention will be described in detail based on the following figures, wherein:

FIG. 1 is a structural drawing showing the overall configuration of a radiation image photographing device relating to an exemplary embodiment;

FIG. 2 is a schematic drawing showing the schematic configuration of one pixel of an X-ray detecting element relating to the exemplary embodiment;

FIG. 3 is a plan view showing the configuration of the X-ray detecting element relating to the exemplary embodiment;

FIG. 4 is a cross-sectional view of the X-ray detecting element relating to the exemplary embodiment;

FIG. 5 is a schematic drawing showing the flow of X-rays that are incident on one pixel of the X-ray detecting element relating to the exemplary embodiment;

FIG. 6 is a graph showing X-ray absorption characteristics of respective materials;

FIG. 7 is a schematic drawing showing the schematic configuration of one pixel of an X-ray detecting element relating to another exemplary embodiment; and

FIG. 8 is a cross-sectional view of the X-ray detecting element relating to the other exemplary embodiment.

### DETAILED DESCRIPTION OF THE INVENTION

A radiation image photographing device 100, to which exemplary embodiments of an image detector of the present invention are applied, will be described hereinafter with reference to the drawings.

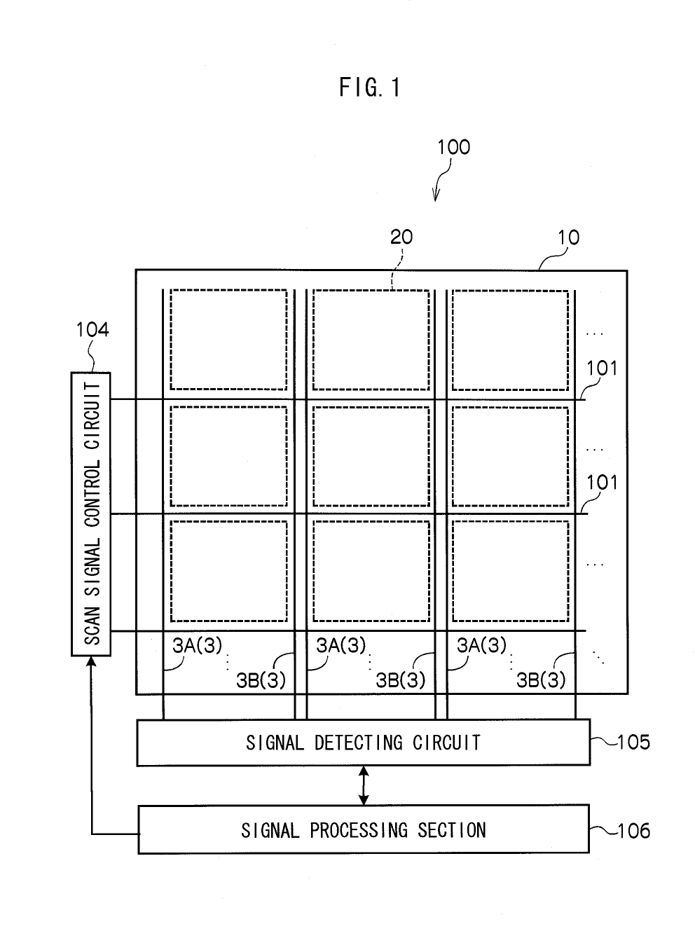

The schematic configuration of the radiation image photographing device 100 relating to the present exemplary embodiment is shown in FIG. 1.

As shown in FIG. 1, the radiation image photographing device 100 relating to the present exemplary embodiment has an X-ray detecting element 10.

As shown in FIG. 1, at the X-ray detecting element 10, plural pixels 20, that detect X-rays as information of pixels configuring a radiation image, are provided in the form of a matrix in one direction (the horizontal direction in FIG. 1) and in a direction (the vertical direction in FIG. 1) intersecting the one direction.

Scan lines 101 are provided in parallel at the X-ray detecting element 10, with each of the scan lines 101 corresponding to a row of pixels in the one direction. Further, signal lines 3 are provided in parallel at the X-ray detecting element 10, with the signal lines 3 corresponding to columns of pixels in the intersecting direction. Note that, at the X-ray detecting element 10 relating to the present exemplary embodiment, two of the signal lines 3 are provided for each of the pixel columns in the intersecting direction. Namely, a signal line 3A is provided at one side (the left side in FIG. 1) of the pixels 20 in a pixel column, and a signal line 3B is provided at the other side (the right side in FIG. 1) of the pixels 20.

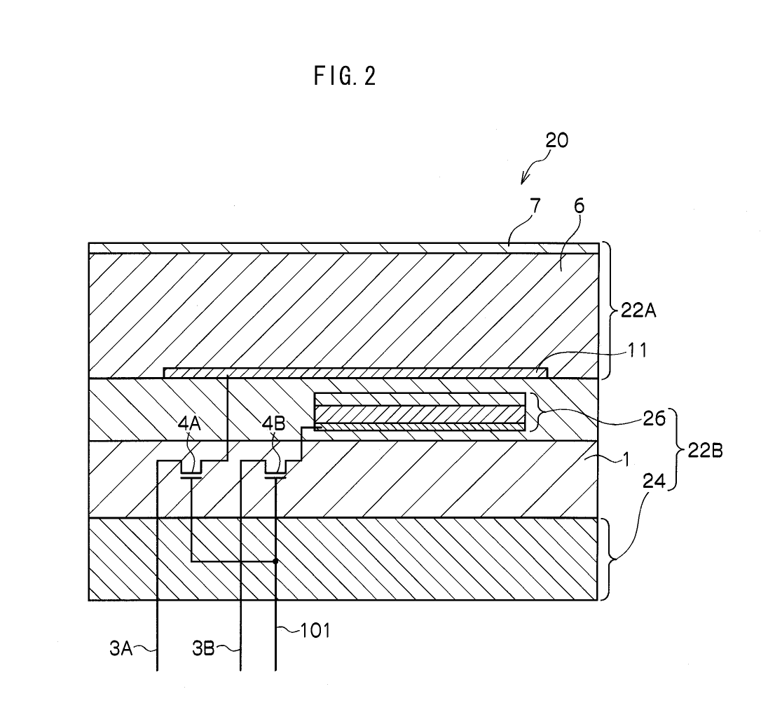

A schematic drawing illustrating the schematic configuration of one of the pixels 20 of the X-ray detecting element 10 relating to the present exemplary embodiment is shown in FIG. 2.

As shown in FIG. 2, two X-ray detecting sections 22A, 22B, that are sensitive to X-rays and detect X-rays and generate charges, are provided so as to be layered at the pixel 20.

The X-ray detecting section 22A is a direct-conversion-type that converts X-rays directly into charges, and accumulates the charges. The X-ray detecting section 22A has a semiconductor layer 6 that generates charges when X-rays are irradiated.

The X-ray detecting section 22B is an indirect-conversion-type that converts X-rays into light once, and thereafter, converts the light into charges and accumulates the charges. The X-ray detecting section 22B has a wavelength converting portion 24 that generates light when X-rays are irradiated, and a sensor portion 26 that generates charges due to the light, that is generated at the wavelength converting portion 24, being illuminated.

The sensor portion 26 is provided on one surface (the upper side surface in FIG. 2) of the substrate 1. The wavelength converting portion 24 is provided on another surface (the lower side surface in FIG. 2) of the substrate 1. The semiconductor layer 6 is provided above the sensor portion 26 that is on the one surface of the substrate 1, so as to cover the region at which the X-ray detecting section 22B is provided.

A TFT switch 4A and a TFT switch 4B are provided at the pixel 20. The TFT switch 4A is connected to the X-ray detecting section 22A, and is for reading-out the charges that are generated at the X-ray detecting section 22A. The TFT switch 4B is connected to the X-ray detecting section 22B, and is for reading-out the charges that are generated at the X-ray detecting section 22B.

The source of the TFT switch 4A is connected to the X-ray detecting section 22A, the drain is connected to the signal line 3A, and the gate is connected to the scan line 101. The source of the TFT switch 4B is connected to the X-ray detecting section 22B, the drain is connected to the signal line 3B, and the gate is connected to the scan line 101.

Due to any of the TFT switches 4A that are connected to the signal line 3A being turned on, an electric signal corresponding to the charge amount that is generated and accumulated at the X-ray detecting section 22A flows to the signal line 3A. Further, due to any of the TFT switches 4B that are connected to the signal line 3B being turned on, an electric signal corresponding to the charge amount that is generated and accumulated at the X-ray detecting section 22B flows to the signal line 3B.

A signal detecting circuit 105 (see FIG. 1), that detects the electric signals that flow-out to the respective signal lines 3A, 3B, is connected to the signal lines 3A, 3B. A scan signal control circuit 104 is connected to the respective scan lines 101. The scan signal control circuit 104 outputs, to the scan lines 101, control signals for turning the TFT switches 4A, 4B ON and OFF.

An amplifying circuit that amplifies the inputted electric signal is incorporated in the signal detecting circuit 105 for each of the signal lines 3A, 3B. The signal detecting circuit 105 amplifies, at the respective amplifying circuits, the electric signals that are inputted from the respective signal lines 3A, 3B, and detects the signals. Due thereto, the signal detecting circuit 105 detects, as information of the respective pixels structuring the image, the charges amounts that are generated at the two X-ray detecting sections 22A, 22B of the respective pixels 20.

A signal processing device 106 is connected to the signal detecting circuit 105 and the scan signal control circuit 104. The signal processing device 106 divides the information of the respective pixels, that are detected at the signal detecting circuit 105, into image information from the signal lines 3A and image information from the signal lines 3B, and carries out predetermined processing thereon. Further, the signal processing device 106 outputs control signals that express signal detecting timings with respect to the signal detecting circuit 105. The signal processing device 106 also outputs control signals that express scan signal outputting timings, with respect to the scan signal control circuit 104. Note that, in the present exemplary embodiment, the respective signal lines 3A, 3B are connected to the one signal detecting circuit 105. However, two of the signal detecting circuits 105 may be provided, and the signal lines 3A and the signal lines 3B may be connected to the separate signal detecting circuits 105. In accordance with this configuration, a signal detecting circuit, that is used in a conventional X-ray detecting element that detects one radiation image, can be utilized.

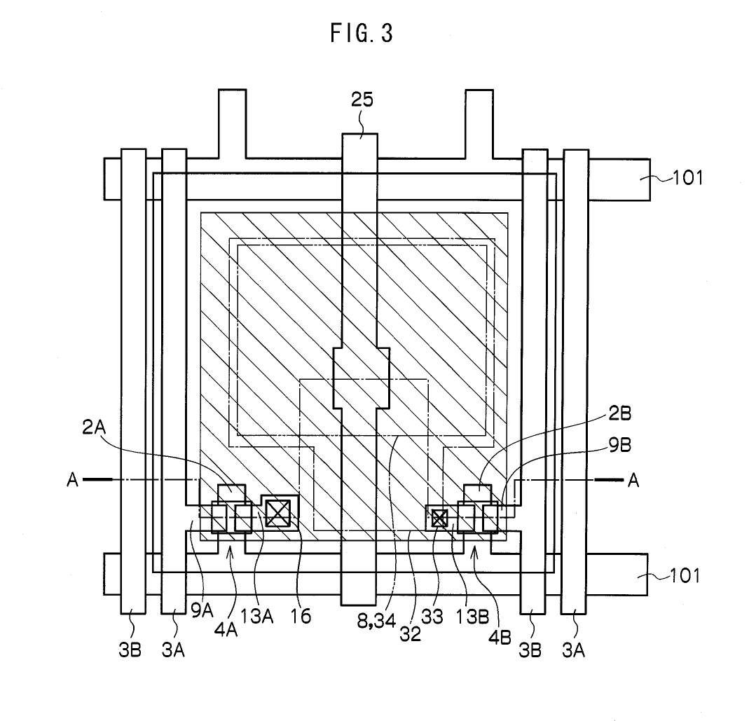

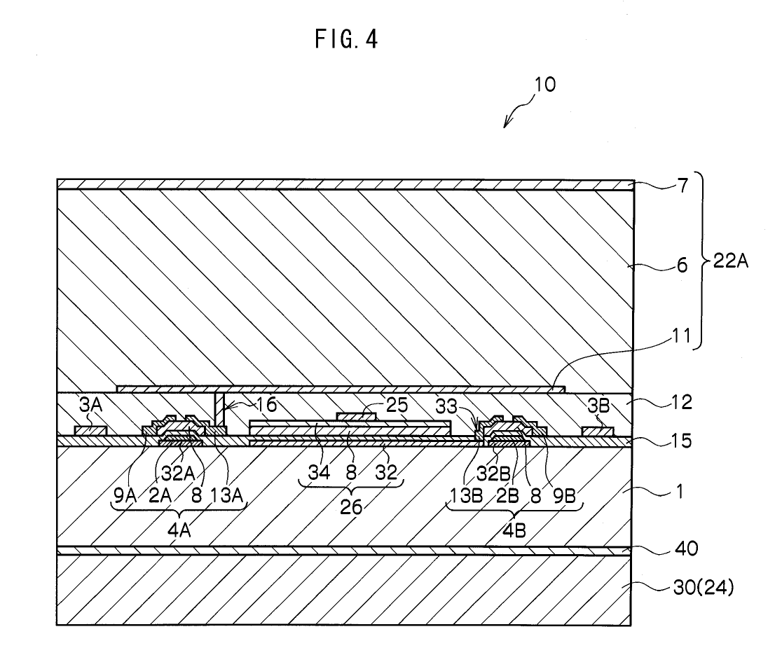

Next, the X-ray detecting element 10 relating to the present exemplary embodiment will be described in further detail with reference to FIG. 3 and FIG. 4. Note that a plan view showing the detailed configuration of the pixel 20 of the X-ray detecting element 10 relating to the present exemplary embodiment is shown in FIG. 3. A cross-sectional view along line A-A of FIG. 3 is shown in FIG. 4.

As shown in FIG. 4, at the X-ray detecting element 10, an electrode 32 is formed on one surface (the upper side surface in FIG. 4) of the insulating substrate 1 that is formed from alkaline-free glass or the like. The electrode 32 is formed from an amorphous transparent conductive oxide film (ITO), and is light-transmissive. Note that, in the present exemplary embodiment, electrodes 32A, 32B are formed from ITO also at gate electrode 2A, 2B regions that will be described later. However, this configuration is not an essential.

The scan line 101 (see FIG. 3) and the two gate electrodes 2A, 2B are formed at the upper layer of the substrate 1 and the electrode 32. The gate electrodes 2A, 2B are respectively connected to the scan line 101. The wiring layer at which the scan line 101 and the gate electrodes 2A, 2B are formed (hereinafter, this wiring layer will also be called a “first signal wiring layer”), is formed by using Al or Cu, or a layered film formed mainly of Al or Cu. However, the material of the wiring layer is not limited to these.

An insulating film 15 is formed on the first signal wiring layer on the entire surface thereof. The regions of the insulating film 15, which regions are positioned on the gate electrodes 2A, 2B, act as gate insulating films at the TFT switches 4A, 4B. Further, the region of the insulating film 15, which region is positioned on the electrode 32, acts as an insulating layer at an MIS photodiode that will be described later. The insulating film 15 is formed from, for example, SiNₓ or the like. The insulating film 15 is formed by, for example, CVD (Chemical Vapor Deposition). A contact hole 33 is formed in the insulating film 15 at the electrode 32 end portion.

A semiconductor layer 8 is formed on the insulating film 15 at positions corresponding to the gate electrodes 2A, 2B and at a position corresponding to the electrode 32. The regions of the semiconductor layer 8 that are positioned on the gate electrodes 2A, 2B act as semiconductor active layers (channel portions) at the TFT switches 4A, 4B. The region of the semiconductor layer 8 that is positioned on the electrode 32 acts as a semiconductor layer at the MIS photodiode that will be described later. The semiconductor layer 8 is formed from, for example, an amorphous silicon film.

Source electrodes 9A, 9B and drain electrodes 13A, 13B are formed on the above-described layers. The source electrodes 9A, 9B and the drain electrodes 13A, 13B, as well as the signal lines 3A, 3B, are formed at the wiring layer at which the source electrodes 9A, 9B and the drain electrodes 13A, 1 3B are formed (hereinafter, this wiring layer will also be called a “second signal wiring layer”). Further, in the second signal wiring layer, an electrode 34 is formed on the semiconductor layer 8. The source electrode 9A is connected to the signal line 3A (see FIG. 3). The source electrode 9B is connected to the signal line 3B. The drain electrode 13B is connected to the electrode 32 via the contact hole 33. The second signal wiring layer, in which the source electrodes 9A, 9B, the drain electrodes 13A, 13B, the electrode 34 and the signal wires 3A, 3B are formed, is formed by using Al or Cu, or a layered film formed mainly of Al or Cu. However, the material of the wiring layer is not limited to these.

A contact layer (not illustrated) is formed between, on the one hand, the source electrodes 9A, 9B, the drain electrodes 13A, 13B and the electrode 34, and, on the other hand, the semiconductor layer 8. The contact layer is formed from an impurity doped semiconductor such as an impurity doped amorphous silicon or the like.

At the X-ray detecting element 10 relating to the present exemplary embodiment, the TFT switch 4A is configured by the gate electrode 2A, the gate insulating film 15, the source electrode 9A, the drain electrode 13A and the semiconductor layer 8. Further, in the X-ray detecting element 10 relating to the present exemplary embodiment, the TFT switch 4B is configured by the gate electrode 2B, the gate insulating film 15, the source electrode 9B, the drain electrode 13B and the semiconductor layer 8. Note that, at the TFT switch 4A, the source electrode 9A and the drain electrode 13A are opposite due to the polarities of the charges generated at the X-ray detecting section 22A. Further, at the TFT switch 4B, the source electrode 9B and the drain electrode 13B are opposite due to the polarities of the charges generated at the X-ray detecting section 22B.

At the X-ray detecting element 10 relating to the present exemplary embodiment, the MIS photodiode is configured by the electrode 32, the semiconductor layer 8, the insulating film 15 and the electrode 34. In the present exemplary embodiment, this photodiode corresponds to the sensor portion 26.

A common electrode line 25 is formed parallel to the signal lines 3A, 3B on the second signal wiring layer, at the central portion of the pixel 20. The common electrode line 25 is connected to the electrode 34. The common electrode line 25 is connected to an unillustrated bias power source, and bias voltage of around several tens of V is supplied thereto from the bias power source.

An interlayer insulating film 12 is formed on substantially the entire surface of the region on the substrate 1 where the pixel 20 is provided (substantially the entire region). The interlayer insulating film 12 is formed from an organic material such as an acrylic resin or the like that is photosensitive. The film thickness of the interlayer insulating film 12 is 1 to 4 μm, and the dielectric constant thereof is 2 to 4. In the X-ray detecting element 10 relating to the present exemplary embodiment, the capacity between the metals that are disposed at the upper layer and the lower layer of the interlayer insulating film 12 is kept low by the interlayer insulating film 12. Further, generally, such a material also functions as a flattening (leveing) film. Accordingly, the interlayer insulating film 12 also has the effect of flattening the steps (number of stepped levels due to layered films) of the lower layer. Because the shape of a semiconductor layer 6 that is disposed at the upper layer is flattened by the interlayer insulating film 12, a decrease in the absorption efficiency due to unevenness of the semiconductor layer 6, and an increase in leak current can be suppressed. A contact hole 16 is formed in the interlayer insulating film 12 at a position opposing the drain electrode 13A.

At each of the pixels 20, a lower electrode 11 is formed on the interlayer insulating film 12 so as to cover the pixel region while filling-in the contact hole 16. The lower electrode 11 is formed from an amorphous transparent conductive oxide film (ITO), and is connected to the drain electrode 13A.

The semiconductor layer 6 is formed uniformly on substantially the entire surface of the pixel region (the region that is the object of detection), at which the pixel 20 on the substrate 1 is provided, on the lower electrode 11. Due to electromagnetic waves such as X-rays or the like being irradiated thereon, the semiconductor layer 6 generates charges (electron-hole pairs) at the interior thereof. Namely, the semiconductor layer 6 is electromagnetic-wave-conductive, and converts the image information by the X-rays into charge information. The semiconductor layer 6 is formed, for example, from amorphous a-Se (amorphous selenium) whose main component is selenium. Here, main component means having a content of greater than or equal to 50%.

An upper electrode 7 is formed on the semiconductor layer 6. An unillustrated bias power source is connected to the upper electrode 7, and bias voltage of around several kV is supplied from the bias power source to the upper electrode 7.

In the present exemplary embodiment, the lower electrode 11, the semiconductor layer 6 and the upper electrode 7 correspond to the X-ray detecting section 22A.

On the other hand, a scintillator 30 that is formed from GOS or the like is affixed to the reverse surface of the substrate 1 by using an adhesive resin 40 having low light absorbance, or the like.

In the present exemplary embodiment, the scintillator 30 corresponds to the wavelength converting portion 24.

The operation of the radiation image photographing device 100 relating to the present exemplary embodiment will be described next.

At the radiation image photographing device 100, when a radiation image is photographed, X-rays that have passed through a subject are irradiated onto the X-ray detecting element 10. A high energy component and a low energy component are included in the X-rays that have passed through the subject.

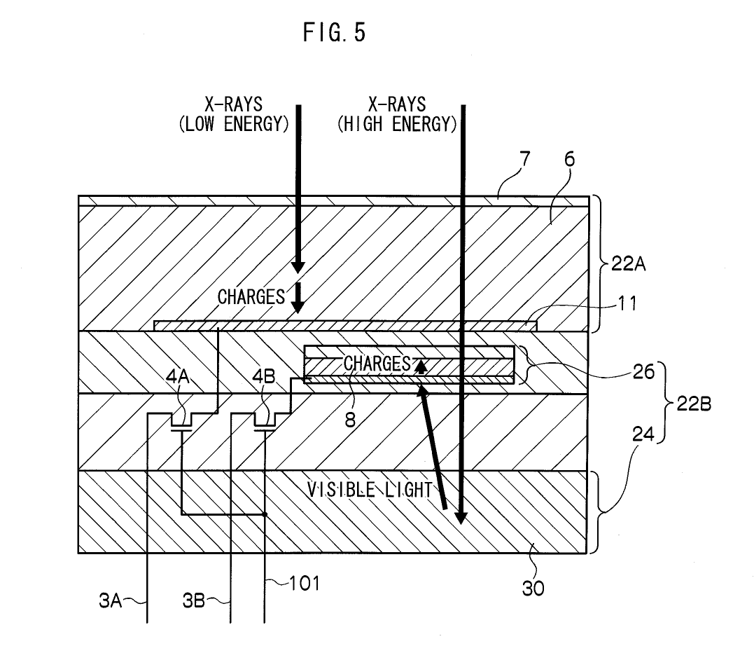

As shown in FIG. 5, at the X-ray detecting element 10, the X-ray detecting sections 22A, 22B are layered at each of the pixels 20. Therefore, the low energy X-rays are absorbed at the X-ray detecting section 22A and do not reach the X-ray detecting section 22B. On the other hand, the high energy X-rays pass through the X-ray detecting section 22A and reach the X-ray detecting section 22B. Accordingly, the X-ray detecting section 22A is sensitive to low energy X-rays. On the other hand, the X-ray detecting section 22B is sensitive to high energy X-rays.

At the X-ray detecting section 22A, charges are generated within the semiconductor layer 6 due to X-rays being irradiated on the semiconductor layer 6. At the X-ray detecting section 22B, the X-rays are converted into visible light at the scintillator 30, and the converted visible light is illuminated onto the semiconductor layer 8, and charges are generated. Note that, in the case of the direct-conversion-type that converts X-rays directly into charges at the semiconductor layer 6 such as the X-ray detecting section 22A, if the semiconductor layer 6 is thick, there are cases in which the charges generated at the semiconductor layer 6 cannot be accumulated sufficiently at the lower electrode 11. Therefore, in the case of a direct-conversion-type, a storage capacitor that accumulates the charges gathered by the lower electrode 11 may be provided.

In the X-ray detecting element 10 relating to the present exemplary embodiment, the X-ray detecting section 22A is a direct-conversion-type, and a-Se (amorphous selenium) is used at the semiconductor layer 6. Further, at the X-ray detecting element 10 relating to the present exemplary embodiment, the X-ray detecting section 22B is an indirect-conversion-type, and GOS is used at the scintillator 30.

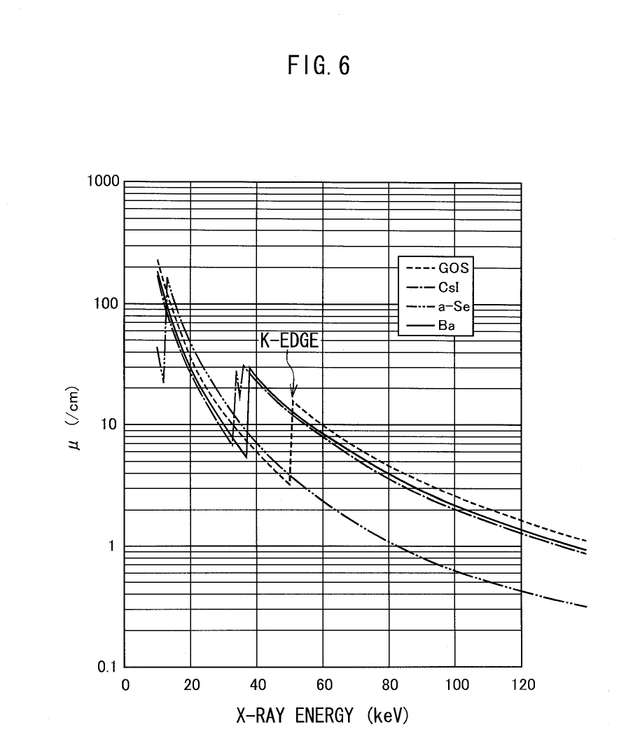

X-ray absorption characteristics of respective materials are shown in FIG. 6.

As shown in FIG. 6, most of the low energy (<40 [KeV]) are absorbed by a-Se. Therefore, although GOS has an absorption rate that is substantially equivalent to that of a-Se, with GOS, few low energy X-rays reach the scintillator 30 that is at the lower layer. Most of the low energy X-rays are detected at the X-ray detecting section 22A that has the semiconductor layer 6.

On the other hand, a-Se does not have a K absorption edge (K-edge) at the high energy portion. Therefore, there is little absorption of high energy radiation (>50 [KeV]) by a-Se. In contrast, with GOS, because the K-edge is in the vicinity of 50 [KeV], high energy X-rays can be absorbed efficiently.

Accordingly, at the X-ray detecting element 10 relating to the present exemplary embodiment, the X-ray detecting section 22A has high sensitivity with respect to low energy x-rays. On the other hand, the X-ray detecting section 22B has high sensitivity with respect to high energy X-rays.

Note that, in the present exemplary embodiment, a low energy portion of the X-rays is defined as <40 [KeV], and a high energy portion of the X -rays is defined as >50 [KeV]. However, the way of dividing energy into high and low is not limited to the same. For example, in a case of angiographic imaging using I (iodine), approximately 33 [KeV], that is the K absorption edge of I, is the boundary between low energy and high energy. Further, in a case of separating bone portions and soft tissue, because the K absorption edge of Ca is 3.6 [KeV] that is not included in the X-rays that are used, the K absorption edge of the element that is included in the converting material of the X-ray detecting section is considered to be the boundary between low energy and high energy. Note that, in the case of imaging, it is preferable that the K absorption edge of the contrast medium and the K absorption edge of the converting material be close.

In this way, because the X-ray detecting section 22A photographs the low energy radiation image, it is preferable that the absorption rate μ of X-rays of the low energy portion be greater than or equal to that of the X-ray detecting section 22B. On the other hand, because the X-ray detecting section 22B photographs the high energy radiation image, a combination of materials at which the absorption rate μ of X-rays of the high energy portion is greater than that of the X-ray detecting section 22A is ideal.

In the present exemplary embodiment, the combination of the materials of the semiconductor layer 6 and the scintillator 30 is made to be a-Se and GOS, but a-Se and CsI (cesium iodide), and a-Se and Ba (barium) also suffice. Even with other materials, radiation images by X-rays having different energies can be obtained provided that the combination of materials satisfies the above-described concept.

At the time of reading-out the image, on signals are successively applied to the gate electrodes 2A, 2B of the TFT switches 4A, 4B via the scan lines 101. Due thereto, the TFT switches 4A, 4B are successively turned on. The charges generated at the X-ray detecting sections 22A flow to the signal lines 3A as electric signals. Further, the charges generated at the X-ray detecting sections 22B flow to the signal lines 3B as electric signals.

On the basis of the electric signals that flow-out to the respective signal lines 3A, 3B, the signal detecting circuit 105 detects the charge amounts, that are generated at the X-ray detecting sections 22A and the X-ray detecting sections 22B, as information of the respective pixels structuring the image. The signal processing device 106 divides the information of the respective pixels detected at the signal detecting circuit 105, into image information from the signal lines 3A and image information from the signal lines 3B, and carries out predetermined processings thereon. In this way, the radiation image photographing device 100 relating to the present exemplary embodiment can obtain image information that expresses the radiation image expressed by the high energy X-rays irradiated on the X-ray detecting element 10, and image information that expresses the radiation image expressed by the low energy X-rays.

Further, the radiation image photographing device 100 relating to the present exemplary embodiment can obtain an energy subtraction image by carrying out subtraction image processing by using the obtained image information expressed by the high energy X-rays and image information by the low energy X-rays.

As described above, in accordance with the present exemplary embodiment, the X-ray detecting sections 22A, 22B are disposed so as to be layered at each of the pixels 20 of the X-ray detecting element 10. Therefore, radiation images of two types of energy are obtained by the irradiation of X-rays a single time, without positional offset arising between the pixels of the radiation image expressed by the high energy X-rays and the radiation image expressed by the low energy X-rays that are obtained by the X-ray detecting element 10.

Further, the radiation image photographing device 100 relating to the present exemplary embodiment can be configured by a single X-ray detecting element, as compared with being configured by superposing two X-ray detecting elements as is the conventional case. Therefore, an increase in costs at the time of manufacturing the radiation image photographing device 100 relating to the present exemplary embodiment case be suppressed.

Further, at the radiation image photographing device 100 relating to the present exemplary embodiment, the sensor portion 26 is made to be an MIS photodiode. Moreover, in the radiation image photographing device 100 relating to the present exemplary embodiment, the semiconductor active layer of the TFT switches 4A, 4B, and the semiconductor layer of the sensor portion 26, are structured at the same layers by the semiconductor layer 8. Further, the insulating layer of the TFT switches 4A, 4B and the insulating layer of the sensor portion 26, are structured at the same layer by the insulating film 15. Accordingly, at the radiation image photographing device 100 relating to the present exemplary embodiment, an increase in costs at the time of manufacturing the X-ray detecting element 10 is suppressed.

Note that, although the above exemplary embodiment describes a case in which the X-ray detecting section 22A is a direct-conversion-type, the present invention is not limited to the same. For example, the X-ray detecting section 22A may be an indirect-conversion-type. Further, a case is described above in which the X-ray detecting section 22B is an indirect-conversion-type, but the present invention is not limited to the same. For example, the X-ray detecting section 22B may be a direct-conversion-type.

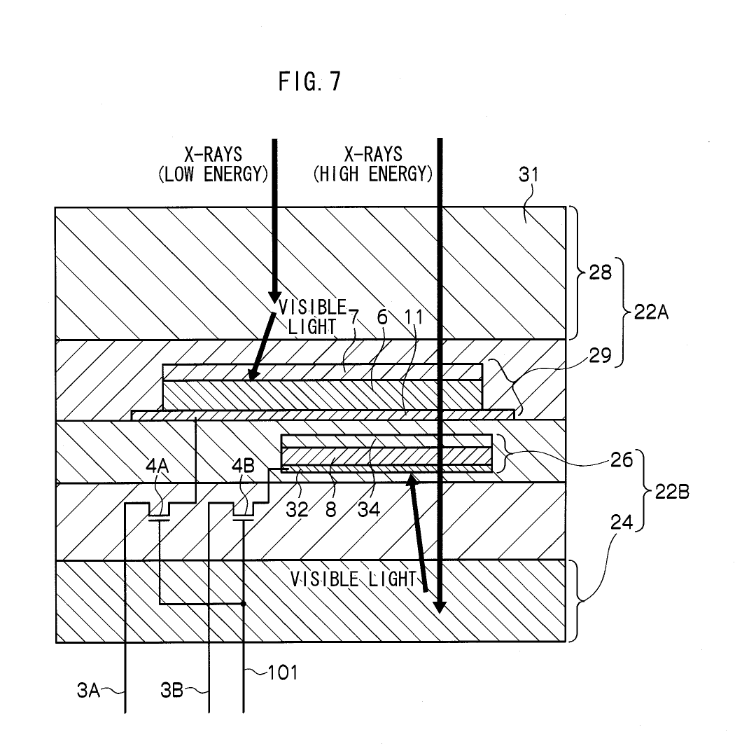

A schematic drawing showing the schematic configuration of one of the pixels 20 of the X-ray detecting element 10, in a case in which the X-ray detecting section 22A is an indirect-conversion-type, is shown in FIG. 7. The X-ray detecting section 22A shown in FIG. 7 has, at one surface (the upper surface in FIG. 7) side of the substrate 1, a wavelength converting portion 28 that generates light when X-rays are irradiated, and a sensor portion 29 that generates charges due to the light, that is generated at the wavelength converting portion 28, being illuminated.

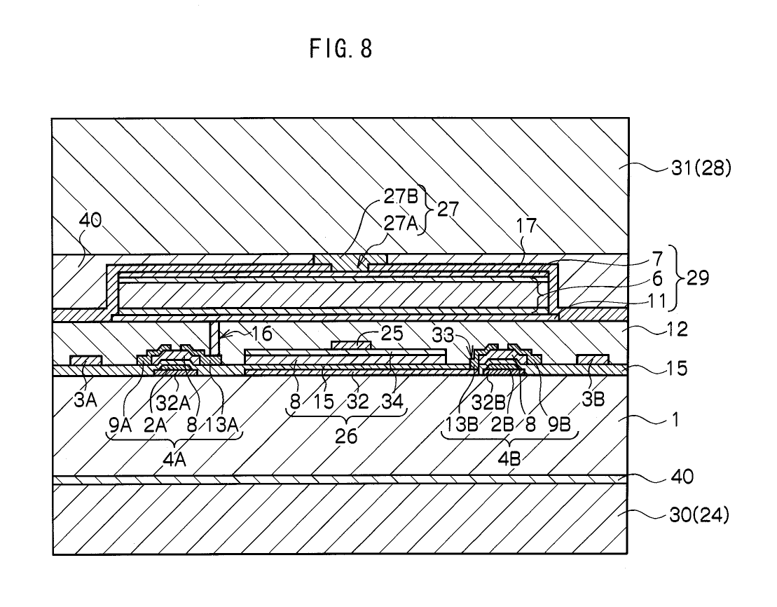

The detailed configuration of the X-ray detecting element 10, in a case in which the X-ray detecting section 22A is an indirect-conversion-type, is shown in FIG. 8. Note that description of portions that are the same as those of FIG. 4 is omitted.

The contact hole 16 is formed in the interlayer insulating film 12 at a position opposing the drain electrode 13A.

At each of the pixels 20, the lower electrode 11 is formed on the interlayer insulating film 12 so as to cover the pixel region while filling-in the contact hole 16. The lower electrode 11 is formed from an amorphous transparent conductive oxide film (ITO), and is connected to the drain electrode 13A. If the semiconductor layer 6 is thick at around 1 μm, there are hardly any limitations on the material of the lower electrode 11 provided that it is conductive. Therefore, there is no problem if the lower electrode 11 is formed by using a conductive metal such as an Al material, ITO (indium tin oxide) or the like.

On the other hand, if the film thickness of the semiconductor layer 6 is thin (around 0.2 to 0.5 μm), the absorption of light at the semiconductor layer 6 is insufficient. Therefore, it is preferable that the lower electrode 11 be an alloy, or a layered film, formed mainly of a light-blocking metal. Note that a light-blocking film may be formed by a light-blocking member between the semiconductor layer 6 and the semiconductor layer 8, for example, on the interlayer insulating film 12, for the purpose of preventing incidence of light.

The semiconductor layer 6 that functions as a photodiode is formed on the lower electrode 11. For example, a photodiode of a PIN structure is employed as the semiconductor layer 6, and the semiconductor layer 6 is formed by layering an n⁺ layer, an i layer and a p⁺ layer in that order from the lower layer. Note that the lower electrode 11 is made to be larger than the semiconductor layer 6.

An upper electrode 7 is formed on the semiconductor layer 6. A material having high light-transmittance such as, for example, ITO or IZO (indium zinc oxide) or the like, is used for the upper electrode 7.

The PIN photodiode, that is configured by the lower electrode 11, the semiconductor layer 6 and the upper electrode 7, corresponds to the sensor portion 29.

A protective insulating film 17 is formed on the interlayer insulating film 12 and the upper electrode 7. The protective insulating film 17 is formed from, for example, SiNₓ or the like. The protective insulating film 17 is formed by, for example, CVD. A contact portion 27, that is for connecting the common electrode line 35 and the upper electrode 7, is provided at the protective insulating film 17.

The common electrode line 35 is formed, on the protective insulating film 17, of Al or Cu, or of an alloy or a layered film formed mainly of Al or Cu.

A contact portion 27, that is for connecting the common electrode line 35 and the upper electrode 7, is provided at the protective insulating film 17.

A contact hole 27A, that is formed in the protective insulating film 17, is provided at the center of the contact portion 27. Further, a contact pad 27B is provided at the contact portion 27 so as to cover the contact hole 27A.

The common electrode line 35 is electrically connected to the upper electrode 7 via the contact portion 27 provided at the protective insulating film 17. A bias power source (not shown) is connected to the common electrode line 35. Bias voltage of around several tens of V is supplied from the bias power source.

A scintillator 31 that is formed from GOS is affixed to one surface side of the substrate 1 of the X-ray detecting element 10 that is formed in this way, by using the adhesive resin 40 or the like. The scintillator 31 corresponds to the wavelength converting portion 28.

As shown in FIG. 7 and FIG. 8, in a case in which the X-ray detecting section 22A is made to be an indirect-conversion-type, the X-ray detecting sections 22A, 22B are disposed so as to be layered at each of the pixels 20. Accordingly, radiation images of two types of energy are obtained by the irradiation of X-rays a single time, without positional offset arising between the pixels of the radiation image expressed by the high energy X-rays and the radiation image expressed by the low energy X-rays that are obtained by the X-ray detecting element 10.

Further, in the above-described exemplary embodiments, a filter that absorbs low energy X-rays may be formed between the semiconductor layer 6 and the semiconductor layer 8, e.g., on the interlayer insulating film 12. In a case in which the X-ray detecting section 22A is formed so as to cover the X-ray detecting section 22B as in the above exemplary embodiment, the low energy X-rays are absorbed by the X-ray detecting section 22A. Namely, the X-ray detecting section 22A also functions as a filter that absorbs low energy X-rays. In this way, it is preferable that there be a filter that absorbs low energy X-rays at the X-ray detecting section 22A side of the X-ray detecting section 22B.

Further, the above exemplary embodiments describe cases in which the sensor portion 26 is an MIS photodiode, but the present invention is not limited to the same, and the sensor portion 26 may be a PIN photodiode. Further, the sensor portion 29 may be an MIS photodiode.

Examples of photodiodes that can be formed on an insulating substrate that is formed from alkaline-free glass or the like as in the present exemplary embodiment include:
(1) PIN: P+, amorphous silicon (the I of Intrinsic), and N+ in that order from the lower layer (VDD>0)
(2) NIP: N+, amorphous silicon (the I of Intrinsic), and P+ in that order from the lower layer (VDD<0), where P+=(P-type impurity doped amorphous silicon), N+=(N-type impurity doped amorphous silicon)
(3) MIS: a lower electrode (M) is covered by an insulating film (I), and amorphous silicon (S) and N+ are layered on the insulating film, MIS=Metal, Insulator, Semiconductor
(4) a TFT diode: refer to JP-A No. 6-237007 for example.

For example, in a case in which the sensor portion 29 is made to be a PIN photodiode and the sensor portion 26 is made to be an MIS photodiode (the case shown in FIG. 7 and FIG. 8), the sensor portion 26 can be formed in the same layer as the TFT switches 4A, 4B. Further, when carrying out photographing of diagnostic images at the sensor portion 29, the frame rate can be made to be high-speed.

Moreover, for example, in a case in which the sensor portion 29 is made to be an MIS photodiode and the sensor portion 26 also is made to be an MIS photodiode, the sensor portion 26 can be formed in the same layer as the TFT switches 4A, 4B. In this case, because both photodiodes are MIS photodiodes, the peripheral circuits can be used in common.

As another example, in a case in which the sensor portion 29 is made to be a PIN photodiode and the sensor portion 26 also is made to be a PIN photodiode, there is the need to form the photodiodes separately from the TFT switches 4A, 4B. However, such a configuration can handle increased speed of the frame rate at the time of continuous photographing.

Still further, for example, in a case in which the sensor portion 29 is made to be a PIN photodiode and the sensor portion 26 is made to be a TFT diode, the TFT diode can be used in common as a TFT for switching and as a photosensor.

The above exemplary embodiments describe cases in which, as shown in FIG. 1, one of the scan lines 101 is provided for each row of pixels in the one direction, and the TFT switches 4A, 4B of the respective pixels 20 of the pixel row are connected to the same scan line 101. However, for example, two of the scan lines 101 may be provided for each of the pixel rows in the one direction, and the TFT switch 4A and the TFT switch 4B of each pixel 20 of a pixel row may be connected to the separate scan lines 101, and the TFT switch 4A and the TFT switch 4B may be switched separately. Further, in this case, one of the signal lines 3 may be provided for each of the pixel columns in the intersecting direction, and the TFT switch 4A and the TFT switch 4B may be connected to the same signal line 3.

The above exemplary embodiments describe cases in which the common electrode line 25 is provided at the upper surface side of the sensor portion 26, and the common electrode line 35 is provided at the upper surface side of the sensor portion 29. However, for example, the common electrode line 25 may be provided at the lower surface side of the sensor portion 26, and the common electrode line 35 may be provided at the lower surface side of the sensor portion 29.

Moreover, the configuration (see FIG. 1) of the radiation image photographing device 100 and the configuration (FIG. 2 through FIG. 5, FIG. 7, FIG. 8) of the X-ray detecting element 10, that are described in the exemplary embodiments, are examples. Accordingly, appropriate changes can be made thereto within a scope that does not deviate from the gist of the present invention.

What is claimed is:

1 An X-ray detecting element comprising:
a first X-ray detecting section provided on one surface of a substrate, and detecting irradiated X-rays, and generating charges;
a second X-ray detecting section provided so as to be layered, in a direction of irradiation of X-rays, with respect to the first X-ray detecting section, and detecting X-rays that are transmitted through the first X-ray detecting section, and generating charges;
a first switching element provided on the one surface of the substrate and connected to the first X-ray detecting section, for reading-out charges that are generated at the first X-ray detecting section; and
a second switching element provided on the one surface of the substrate and connected to the second X-ray detecting section, for reading-out charges that are generated at the second X-ray detecting section.

2. The X-ray detecting element of claim 1, wherein the substrate is light-transmissive, and the second X-ray detecting section is configured to include:
a second wavelength converting portion provided on another surface of the substrate, and generating light when X-rays are irradiated thereon; and
a second sensor portion provided on the one surface of the substrate, and generating charges due to illuminated light, that is generated at the second wavelength converting portion.

3. The X-ray detecting element of claim 2, wherein the first switching element and the second switching element are formed in the same layer.

4. The X-ray detecting element of claim 3, wherein the second sensor portion is formed in the same layer as the first switching element and the second switching element, and the first X-ray detecting section is provided, via an interlayer insulating film, at a layer disposed above the layer which includes the first switching element and the second switching element.

5. The X-ray detecting element of claim 4, wherein the first switching element and the second switching element are thin-film transistors, the second sensor portion is an MIS photodiode, and semiconductor active layers of the thin-film transistors that are the first switching element and the second switching element and a semiconductor layer of the MIS photodiode that is the second sensor portion are formed in same layer, and insulating layers of the thin-film transistors and an insulating layer of the photodiode, are formed in same layer.

6. The X-ray detecting element of claim 1, wherein the second X-ray detecting section has, at a first X-ray detecting section side thereof, a filter that absorbs low energy X-rays.

7. The X-ray detecting element of claim 6, wherein the first X-ray detecting section also functions as the filter.

8. The X-ray detecting element of claim 1, wherein the first X-ray detecting section is provided so as to cover a region where the second X-ray detecting section is provided.

9. The X-ray detecting element of claim 1, wherein the first X-ray detecting section is configured to include a semiconductor layer that generates charges when X-rays are irradiated thereto.

10. The X-ray detecting element of claim 1, wherein the first X-ray detecting section is configured to include:
a first wavelength converting portion generating light when X-rays are irradiated thereto; and
a first sensor portion generating charges due to illuminated light, that is generated at the first wavelength converting portion, and
the first wavelength converting portion is provided so as to cover the first sensor portion.

11. The X-ray detecting element of claim 1, wherein the first X-ray detecting section does not have a K absorption edge at a high energy portion.

12. The X-ray detecting element of claim 1, wherein plural pixel portions, that detect X-rays as information of pixels forming a radiation image, are provided at the substrate in a surface direction, and plural first X-ray detecting sections, second X-ray detecting sections, first switching elements, and second switching elements are provided for the respective pixel portions.
